(19) United States
(12) Patent Application Publication
(10) Pub. No.: US 2008/0263319 A1
(43) Pub. Date: Oct. 23, 2008

(54) UNIVERSAL DIGITAL BLOCK WITH INTEGRATED ARITHMETIC LOGIC UNIT

(75) Inventors: Warren Snyder, Snohomish, WA (US); Bert Sullam, Bellevue, WA (US)

Correspondence Address: Stolowitz Ford Cowger, LLP/Cypress, 621 Sw Morrison St., Suite 600, Portland, OR, 97205, US

(73) Assignee: Cypress Semiconductor Corporation, San Jose, CA (US)

(21) Appl. No.: 11/963,661

(22) Filed: Dec. 21, 2007

Related U.S. Application Data
(60) Provisional application No. 60/912,399, filed on Apr. 17, 2007.

(51) Int. Cl. G06F 13/14; G06F 9/02

(52) U.S. Cl. 712/29; 712/28; 712/E09.002

(57) ABSTRACT

An array of universal digital blocks include programmable logic device sections that have uncommitted user programmable logic functions and structural datapath sections that include dedicated and highly configurable arithmetic operators. A routing channel matrix programmably connects to different programmable logic device sections and datapath sections in the different universal digital blocks.

The present application claims priority to U.S. Provisional Application No. 60/912,399, filed Apr. 17, 2007 and is herein incorporated by reference in its entirety.

### TECHNICAL FIELD

The present disclosure relates generally to programmable devices, and more particularly to a Universal Digital Block (UDB) with an integrated Arithmetic Logic Unit (ALU).

### BACKGROUND

Field-programmable gate arrays (FPGAs) and programmable logic devices (PLDs) have been used in data communication and telecommunication systems. Conventional PLDs and FPGAs consist of an array of programmable elements, with the elements programmed to implement a fixed function or equation. Some currently-available Complex PLD (CPLD) products comprise arrays of logic cells. Conventional PLD devices have several drawbacks, such as high power consumption and large silicon area.

In developing complex electronic systems, there is often a need for additional peripheral units, such as operational and instrument amplifiers, filters, timers, digital logic circuits, analog to digital and digital to analog converters, etc. As a general rule, implementation of these extra peripherals create additional difficulties: extra space for new components, additional attention during production of a printed circuit board, and increased power consumption. All of these factors can significantly affect the price and development cycle of the project.

The introduction of Programmable System on Chip (PSoC) chips feature digital and analog programmable blocks, which allow the implementation of a large number of peripherals. A programmable interconnect allows analog and digital blocks to be combined to form a wide variety of functional modules. The digital blocks consist of smaller programmable blocks and are configured to provide different digital functions. The analog blocks are used for development of analog elements, such as analog filters, comparators, inverting amplifiers, as well as analog to digital and digital to analog converters. Current PSoC architectures provide only a coarse grained digital programmability in which a few fixed functions with a small number of options are available.

### SUMMARY

An array of universal digital blocks consisting of sections that include uncommitted user programmable logic (PLD, Programmable Logic Device) functions and datapath sections that include structural data and arithmetic operators. A routing channel matrix programmably connects to different selectable elements in the programmable logic device sections and the datapath sections in the array of universal digital blocks.

Configuration registers dynamically program different functions performed by the structural datapath sections and programmable logic sections, and statically configure how the structural datapath and programmable logic device sections connect to the routing channel.

The datapath sections comprise dedicated data buffers, a dedicated arithmetic logic unit, and dedicated conditional operators. The arithmetic unit can include a dedicated data shifter and a dedicated data bit mask. A Random Access Memory (RAM) in the datapath is configured to store addressable data values that dynamically program the different arithmetic operators. An output multiplexer programmably couples different outputs from the arithmetic operators to other universal digital blocks through the routing channel.

Dedicated data registers are accessible through a micro-controller and provide inputs to the arithmetic operators. Parallel data buses are coupled to the data registers and are programmably coupled to the routing channel.

The first set of user programmable uncommitted logic in at least some of the universal digital blocks are programmed into a first set of user programmed logic functions. The second set of dedicated arithmetic sequencer elements in at least some of the universal digital blocks provide a second set of user arithmetic operations that operate in conjunction with the user programmed logic functions. The routing channel is then used to selectively couple at least some of the user programmed logic functions with at least some of the dedicated arithmetic sequencer elements in different universal digital blocks.

A micro-controller monitors data signals and can dynamically reprogram the arithmetic sequencer elements or user programmed logic elements in one or more of the universal digital blocks to perform different arithmetic functions or programmable logic sequences according to the monitored data signals. The micro-processor can also dynamically change, through programmable routing configuration which of the arithmetic sequencer elements in which of the universal digital blocks are coupled together according to the monitored data signals.

### BRIEF DESCRIPTION OF THE DRAWINGS

FIG. 1 is a schematic block diagram illustrating an example Programmable System on a Chip (PSoC) architecture that includes a Universal Digital Block (UDB) array.

FIG. 2 is a schematic block diagram illustrating one of the UDBs in FIG. 1 that includes both uncommitted PLD blocks and a structural dedicated datapath block.

FIG. 3 is a schematic block diagram illustrating the UDB in FIG. 2 in more detail.

FIG. 4 is a schematic block diagram also showing a datapath block in FIG. 2 in more detail.

FIG. 5 is a schematic block diagram showing conditional logic in the datapath block in more detail.

FIG. 6 is a schematic block diagram showing how the UDBs are programmed using configuration registers.

FIG. 7 is a flow diagram showing how a micro-controller or other Central Processing Unit (CPU) programs the UDBs.

### INTRODUCTION

A new Universal Digital Block (UDB) architecture combines PLDs and a datapath module in the same digital logic block to allow for the implementation of universal embedded digital functions. The new UDB architecture includes an integrated ALU that removes limitations associated with fixed functionality and provides users with the ability to customize digital operations to match system requirements.

### DETAILED DESCRIPTION

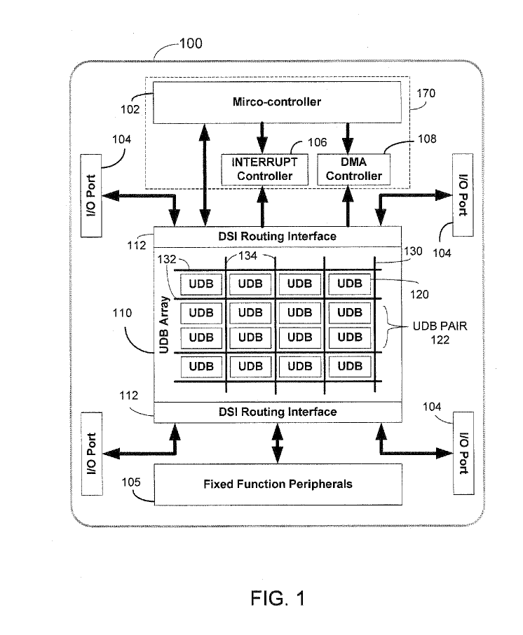

FIG. 1 is a high level view of a Universal Digital Block (UDB) array 110 contained within a Programmable System on a Chip (PSoC) Integrated Circuit (IC) 100. The UDB array 110 includes a programmable interconnect matrix 130 that connects together different UDBs 120. The individual UDBs 120 each include a collection of uncommitted logic in the form of Programmable Logic Devices (PLDs) and structural dedicated logic elements that form a datapath 210 shown in more detail in below.

### UDB Array

The UDB array 110 is arranged into UDB pairs 122 that may or may not be connected together through the interconnect matrix 130. The UDB pairs 122 each include two UDBs 120 that can be tightly coupled to a shared horizontal routing channel 132. The UDB pairs 122 can also be programmably connected to the horizontal routing channels 132 of other UDB pairs 122 either in the same horizontal row or in different rows through vertical routing channels 134. The horizontal and vertical routing channels and other switching elements are all collectively referred to as the interconnect matrix 130.

A Digital System Interconnect (DSI) routing interface 112 connects a micro-controller system 170 and other fixed function peripherals 105 to the UDB array 110. The micro-controller system 170 includes a micro-controller 102, an interrupt controller 106, and a Direct Memory Access (DMA) controller 108. The other peripherals 105 can be any digital or analog functional element that is preconfigured in PSoC 100. The DSI 112 is an extension of the interconnect matrix 130 at the top and bottom of the UDB array 110.

### UDB

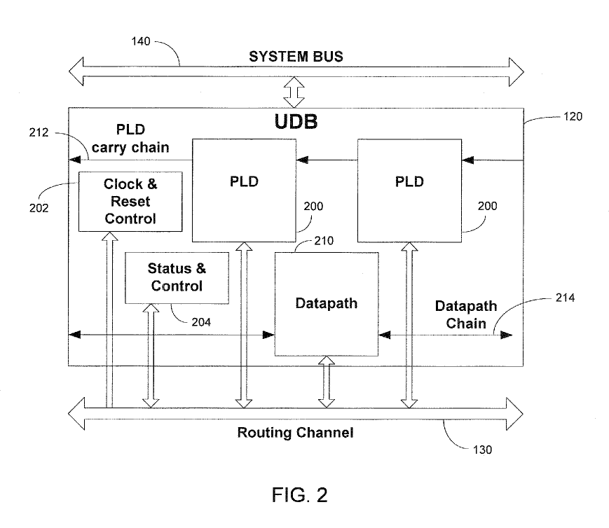

FIG. 2 is a top-level block diagram for one of the UDBs 120. The major blocks include a pair of Programmable Logic Devices (PLDs) 200. The PLDs 200 take inputs from the routing channel 130 and form registered or combinational sum-of-products logic to implement state machines, control for datapath operations, conditioning inputs and driving outputs.

The PLD blocks 200 implement state machines, perform input or output data conditioning, and create look-up tables. The PLDs 200 can also be configured to perform arithmetic functions, sequence datapath 210, and generate status. PLDs are generally known to those skilled in the art and are therefore not described in further detail.

The datapath block 210 contains highly structured dedicated logic that implements a dynamically programmable ALU, comparators, and condition generation. A status and control block 204 allows micro-controller firmware to interact and synchronize with the UDB 120 by writing to control inputs and reading status outputs.

A clock and reset control block 202 provides global clock selection, enabling, and reset selection. The clock and reset block 202 selects a clock for each of the PLD blocks 200, the datapath block 210, and status and control block 204 from available global system clocks or a bus clock. The clock and reset block 202 also supplies dynamic and firmware resets to the UDBs 120.

Routing channel 130 connects to UDB I/O through a programmable switch matrix and provides connections between the different elements of the UDBs in FIG. 2. A system bus interface 140 maps all registers and RAMs in the UDBs 120 into a system address space and are accessible by the micro-controller 102 shown in FIG. 1.

The PLDs 200 and the datapath 210 have chaining signals 212 and 214, respectively, that enable neighboring UDBs 120 to he linked to create higher precision functions. The PLD carry chain signals 212 are routed from the previous adjacent UDB 120 in the chain, and routed through each macrocell in both of the PLDs 200. The carry out is then routed to the next UDB 120 in the chain. A similar connectivity is provided for the set of conditional signals generated by the datapath chain 214 between datapath blocks 210 in adjacent UDBs 120.

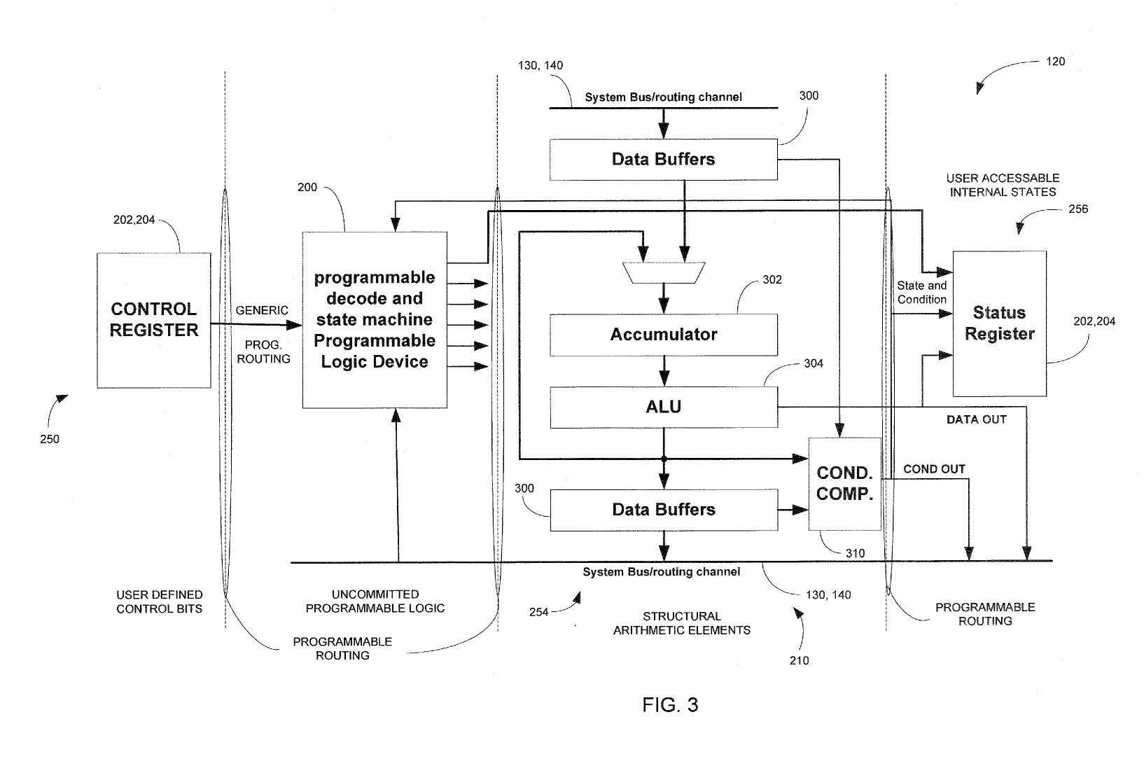

Referring to FIG. 3, each UDB 120 comprises a combination of user defined control bits that are loaded by the micro-controller 102 into control register 250. The control register 250 is part of the control blocks 202 and 204 described above in FIG. 2. The control register 250 feeds uncommitted programmable logic 200 and control for datapath inputs. The same control blocks 202 and 204 described above in FIG. 2 also include associated status registers 256 that allow the micro-controller 102 to selectably read different internal states for both the uncommitted logic elements and structural arithmetic elements 254 within the datapath 210.

The datapath 210 comprises highly structured logic elements 254 that include a dynamically programmable ALU 304, conditional comparators 310, accumulators 302, and data buffers 300. The ALU 304 is configured to perform instructions on accumulators 302, and to perform arithemetic sequences as controlled by a sequence memory. The conditional comparators 310 can operate in parallel with the ALU 304. The datapath 210 is further optimized to implement typical embedded functions, such as timers, counters, pseudo random sequence generators, Cyclic Redunduncy Checkers (CRC), Pulse Width Modulators (PWM), etc.

The combination of uncommitted PLDs 200 with a dedicated datapath module 210 allow the UDBs 120 to provide embedded digital functions with more silicon efficient processing. The dedicated committed structural arithmetic elements 254 more efficiently implement arithmetic sequencer operations, as well as other datapath functions. Since the datapath 210 is structural, fewer gates are needed to implement these structural elements 254 and fewer interconnections are needed to connect the structural elements 254 together into an arithmetic sequencer. Implementing the same datapath 210 with PLDs could require a much greater quantity of additional combinational logic and additional interconnections.

The structured logic in the datapath 210 is also highly programmable to provide a wide variety of different dynamically selectable arithmetic functions. Thus, the datapath 210 not only conserves space on the integrated circuit 100 (FIG. 1) but also is highly configurable similar to PLDs. It has an additional advantage of being dynamically configurable and reconfigurable.

The functionalality of the datapath 210 may be controlled through writes to the control registers 250 allowing the micro-controller 102 to arbitrarily set the system state and selectively control different arithmetic functions. The status registers 256 allow the micro-controller 102 to also identify different states associated with different configured arithmetic operations. The flexible connectivity scheme provided by the routing channel 130 selectively interconnects the different functional element 250, 200, 254, and 256 together as well as programmably connecting these functional element to other UDBs, I/O connections, and peripherals.

Thus, the combination of uncommitted logic 252, structural logic 254, and programmable routing channel 130 provide as much functionality and uses less integrated circuit space, while at the same time providing the potential for increased performance and substantially the same functional configurability.

### Datapath

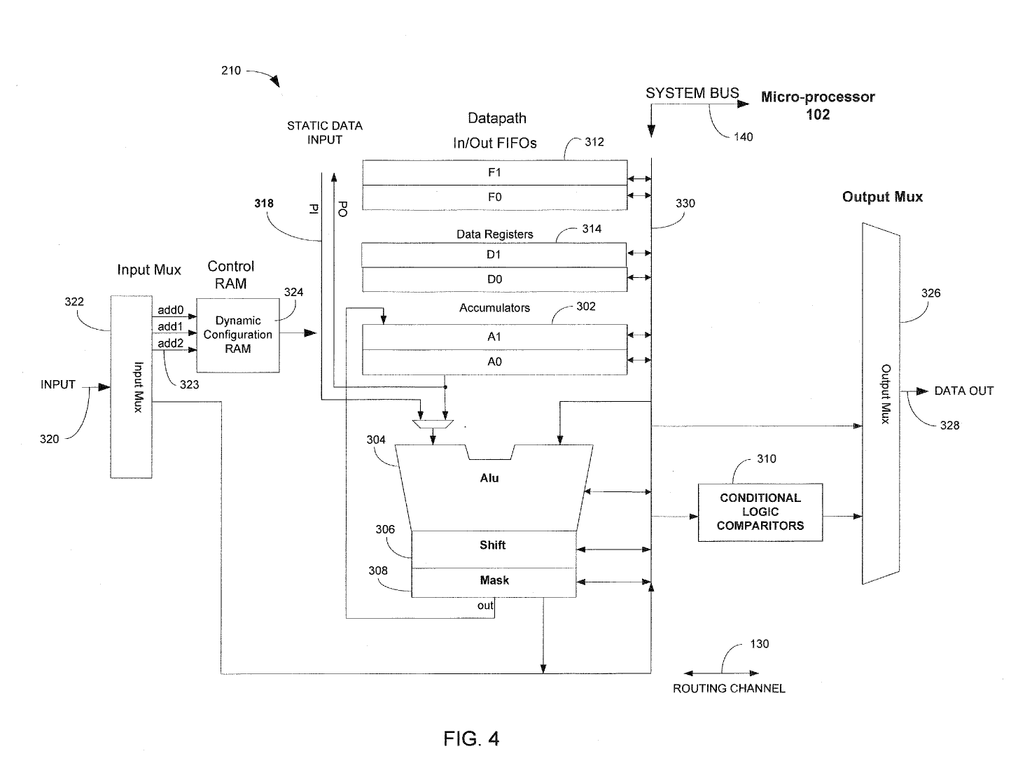

FIG. 4 shows one embodiment of the datapath 210 in more detail. The datapath 210 contains a single cycle ALU 304 and associated conditional logic comparators 310. The datapath 210 can be chained with neighboring datapaths to achieve single cycle functionality with additional bit widths. A RAM based control store 324 dynamically selects the operation and configuration performed in any given cycle.

The datapath 210 is optimized to implement typical embedded functions, such as timers, counters, Pulse Width Modulators (PWMs), Pseudo Random Sequence (PRS) generators, Cyclic Redundancy Checks (CRC), shifters, dead band generators, etc. The addition of the add and subtract functions in ALU 304 also allow support for digital delta-sigma operations.

Internal connections 330 can be externally connected to either the system bus 140 and/or the routing channel 130. Different combinations of connections 330 are interconnected between different datapath components according to their related functions. Connections 330 are shown as a single bus in FIG. 4 for illustrative purposes only and there may or may not be certain connections that are shared by multiple different datapath components.

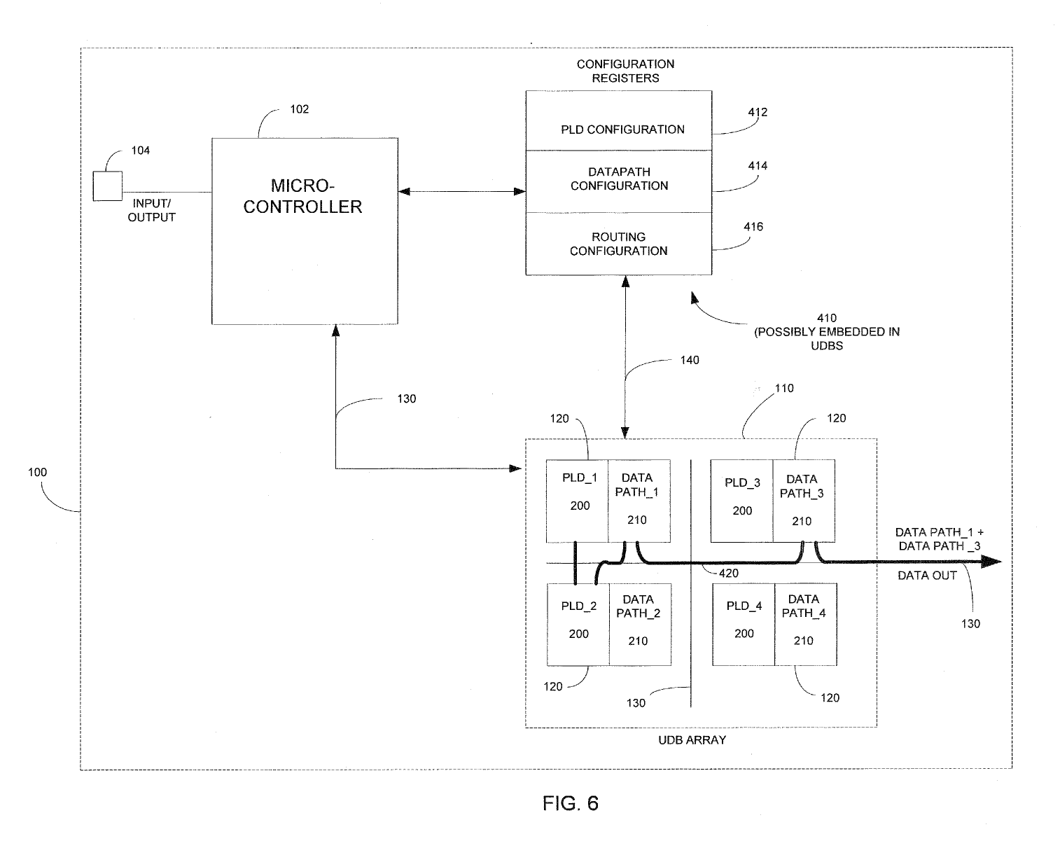

Dynamic configuration is the ability to change the datapath function and interconnect configuration on a cycle-by-cycle basis. This is implemented using the information in configuration RAM 324. The address 323 input to RAM 324 can be routed from any functional element connected to the routing channel 130, and most typically include the PLDs 200 (FIG. 2), I/O pins 104 (FIG. 1), micro-controller 102 (FIG. 6), or PLDs or datapaths from other UDBs 120.

The ALU 304 can perform different general-purpose functions such as increment, decrement, add, subtract, logical AND, OR, XOR, or PASS. In addition to these functions, hardware structures and connections are provided to implement a single cycle CRC operation. In addition to the ALU 304, an independent shifter 306 provides left, right, nibble swap operations. Another independent masking function 308 masks selectable bits output from the ALU 304.

Each datapath 210 includes conditional logic comparators 310 which can be configured to receive a variety of different datapath register inputs. The comparators 310 check for conditions such as zero detect, all one's detect, and overflow. These conditions produce datapath outputs that are selectively routed back through the same datapath 210 or routed through output multiplexer 326 and the routing channel 130 to other UDBs or peripheral components.

Each datapath 210 contains multiple FIFOs 312 that can be individually configured to operate as input buffers or output buffers. When operating as input buffers, the system bus 140 can write to the FIFOs 312 and datapath internal logic elements can read from the FIFOs 312. When operating as output buffers, datapath internal logic elements write to the FIFO 312 and the system bus 140 reads from the FIFO 312. The FIFOs 312 generate status that can be routed to interact with sequencers, interrupt, or DMA requests.

As described above in FIG. 2, the datapath 210 can be configured to chain conditions and signals with neighboring datapaths. The shift, carry, capture, and other conditional signals can also be chained to form higher precision arithmetic, shift, and CRC/PRS functions. For example, 16-bit functions in an 8-bit datapath can be provided by interconnecting two datapaths together, or CRC generation can be implemented between two datapaths 210 using data shifting.

In applications that are oversampled, or don't need the highest clock rates, the ALU block 304 can be efficiently shared with two sets of registers and condition generators. Selected outputs from the ALU 304 and shifter 306 are registered and can be used as inputs in subsequent cycles.

The datapath 210 receives configuration inputs, control inputs, and data inputs. At least some configuration data can be received over input 320 and used for selecting the current address 323 for configuration RAM 324. Input 320 can come from either to the system bus 140 and/or to the routing channel 130. Control inputs can come over the system bus 140 or the routing channel 130 and are used to load the data registers 314 and capture outputs from accumulators 302. Data inputs can also come from the system bus 140 and/or the routing channel 130 and can include shift in and carry in signals received over input multiplexer 322. Other data inputs include parallel data input and output ports 318 that can be programmably connected through the routing channel 130 to the ALU 304.

There are multiple conditional, data, and status signals that can be selectively output via output multiplexer 326. For maximum routing flexibility, any of the status or data output signals connected to output mux 326 can be programmably connected to the routing channel 130.

The datapath 210 has multiple working registers. These registers are readable and writable by the micro-controller 102 and DMA 108 in FIG. 1. The accumulators 302 can be a source for the ALU 304 and a destination of the ALU output. The accumulators 302 can also be loaded from an associated data register 314 or FIFO 312. The accumulators 302 contain the current value of the ALU function, for example, the count, CRC or shift.

### Datapath Condition Generation

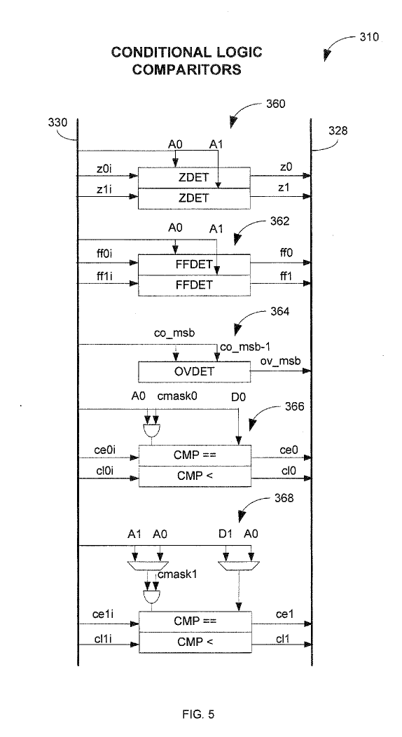

Referring to FIG. 5, conditional logic comparators 310 receive values output from accumulators 302, ALU 304, FIFOs 312, and data registers 314 in FIG. 4. The outputs from condition logic 310 can be programmably connected to the routing channel 130 (FIG. 1) for use in other UDBs 120, for use as interrupts or DMA requests, output to the micro-controller 102 in FIG. 1, or output to the I/O pins 104 in FIG. 1.

Some example conditional logic is shown in FIG. 5. Zero detect logic 360 detects zero data values from one of the accumulators 302. All one's logic 362 detects accumulator values that include all logic 1 values. Overload logic 364 detects most significant bit carry values for overflow conditions. Comparator logic 366 and 368 determine if different values from accumulators 302, data registers 314, and mask 308 are equal, greater than, or less than each other. The inputs to the conditional compare logic shown in FIG. 5 is dynamically configured so that different values from different data path registers can be dynamically selected for inputting into the different comparison functions.

### Dynamic UBD Configuration and Programmability

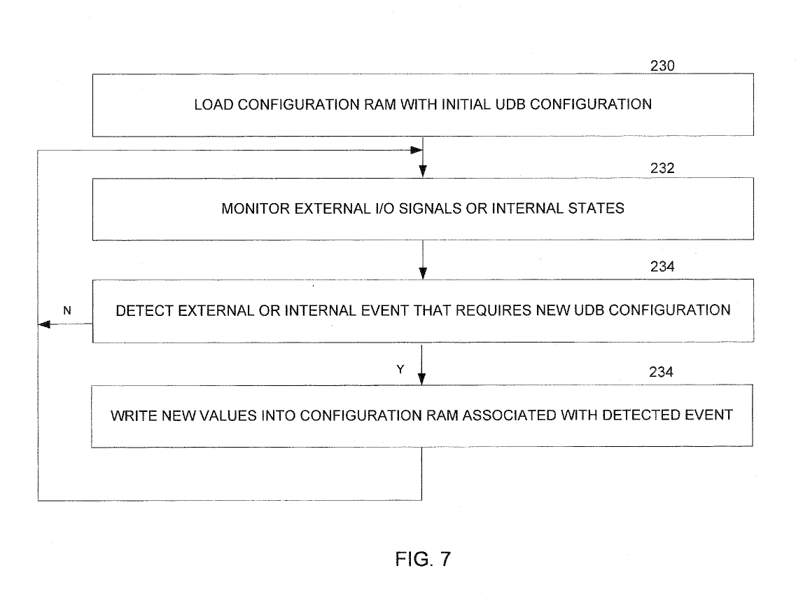

FIGS. 6 and 7 describe in more detail how the PSoC chip provides both static and dynamic programmability and configuration. The micro-controller 102, or some other equivalent programmable CPU, receives external data and control signals from a variety of different Input/Output pins 104. The micro-controller 102 can also receive internal signals from different internal peripherals, such as the UDB array 110, over the interconnect matrix 130.

A Random Access Memory (RAM) and/or a set of configuration registers 410 are directly readable and writeable by the micro-controller 102. Some memory locations 412 are associated with PLD configuration. For example, the micro-controller 102 can write values into memory locations 412 to program how different PLDs 200 operate and how the PLDs 200 are connected with other PLDs 200 and datapaths 210 in the same or in other UDBs 120. Similarly, the micro-controller 102 can write values into memory locations 416 to configure different arithmetic operations in the datapaths 210 and configure routing interconnections between the datapaths 210 and other functional elements in the PSoC IC 100.

The memory section 418 is used to program different arithmetic operations performed by the datapath 210 and different interconnect matrix routing that may be used for these different arithmetic operations. For example, the values in memory locations 418 can determine which internal signals from the ALU 304 in FIG. 4 are output from MUX 326.

FIG. 6 also shows the system bus 140 and routing channel 130 connections between the micro-controller 102, RAM/configuration registers 410, and UDB array 110. This illustrates how a variety of different connections are used to both configure the UDB array 110 and transfer data in and out of the UDB array 110. The RAM/configuration registers 410 are shown as a separate memory element in FIG. 6 for illustrative purposes. However, it should be understood that some or all of the configuration registers 410 can be located in the individual UDBs 120 and in other peripheral elements. Other configuration registers 410 can be stand alone registers that are separately coupled to one or more of the peripheral elements.

Referring both to FIGS. 6 and 7, the micro-controller 102 writes values into random access configuration registers 410 to configure both the connectivity and functionality of the UDB array 110. For example, the micro-controller 102 may load PLD configuration values into configuration registers 412, load datapath configuration values into configuration registers 414, and load routing configuration values for configuring the routing matrix 130 into configuration registers 416.

The micro-controller 102 can then monitor different internal or external events in operation 232. For example, the micro-controller 102 may monitor external signals on I/O pin 104 or may monitor different internal signals or states in the UDB array 110. A particular external or internal signal or state may be detected in operation 234 that requires a new UDB functional operation and/or a new routing configuration.

For example, the micro-controller 102 may detect a signal that requires increased accuracy for a subsequent arithmetic operation. Accordingly, the micro-controller 102 in operation 234 writes different values into particular locations 412, 414, and/or 416 of configuration RAM 410 that reconfigure the UDB array 110 for the new arithmetic operation and/or new interconnect configuration.

In this example, the micro-controller 102 can determine based on some monitored event that both datapath_1 and datapath_3 need to process a set of data. A previous operation may have compared two 8 bit wide data values. However, the micro-controller 102 determines that a next operation requires two 16 bit wide data values to be added together. The micro-controller 102 writes values into RAM section 414 that change the functions performed in the ALUs 304 and/or comparators 310 in datapath 1 and datapath_3 from 8 bit compare operations to a 16 bit add operation.

The micro-controller 102 may also need to reconfigure the interconnect matrix 130 so that the first datapath_1 adds together the first 8 bits of the two data values and datapath_3 adds together the second 8 bits of the two data values. Accordingly, the micro-controller 102 writes values into memory location 416 that connect datapath_1 and datapath_3 together through the interconnect matrix 130 to form a 16 bit wide adder. The new values loaded into memory sections 414 and 416 also connect the carry output 214 (FIG. 2) from datapath 1 with the carry input 214 from datapath_3.

The two halves of the two 16 bit data values are loaded into the data registers 314 (FIG. 4) of datapath_1 and datapath_3, respectively, by the micro-controller 102. A 16 bit add operation is then performed on the 16 bit wide data values by the dynamically programmed 16 bit ALU configured using datapath 1 and datapath_3. This of course is just one example of any number of different arithmetic operations that can be dynamically configured using the UDB array 110.

The system described above can use dedicated processor systems, micro controllers, programmable logic devices, or microprocessors that perform some or all of the operations. Some of the operations described above can be implemented in software and other operations can be implemented in hardware.

For the sake of convenience, the operations are described as various interconnected functional blocks or distinct software modules. This is not necessary, however, and there can be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention can be modified in arrangement and detail without departing from such principles. Claim is made to all modifications and variation coming within the spirit and scope of the following claims.

1. An apparatus, comprising:
digital blocks that include programmable logic device sections that provide uncommitted user programmable logic functions and datapath sections that have structural arithmetic elements; and
a routing channel matrix that programmably connects to different selectable programmable logic device sections in the digital blocks and programmably connects to different selectable datapath sections in the digital blocks.

2. The apparatus according to claim 1 further comprising a configuration memory or configuration registers that dynamically program different functions performed by the datapath sections and dynamically program how different programmable logic device sections and different datapath sections are connected together by the routing channel matrix.

3. The apparatus according to claim 1 wherein the datapath sections comprise dedicated data buffers and a dedicated arithmetic logic unit.

4. The apparatus according to claim 3 wherein the datapath sections further comprise a dedicated data shifter and a dedicated data bit mask.

5. The apparatus according to claim 1 wherein the datapath sections include a Random Access Memory (RAM) configured to store values that dynamically program different arithmetic operations performed by the structural arithmetic elements.

6. The apparatus according to claim 1 wherein the datapath sections include dedicated conditional operators that identify data value conditions.

7. The apparatus according to claim 1 wherein the datapath sections include output multiplexers that programmably couple different outputs from the structural arithmetic elements to other programmable logic device sections and other datapath sections through the routing channel matrix.

8. The apparatus according to claim 1 wherein the datapath sections include dedicated data registers that are accessible by a micro-controller.

9. The apparatus according to claim 8 wherein the datapath sections further comprise parallel data buses that are coupled between the data registers and the routing channel matrix.

10. An integrated circuit, comprising:
multiple digital blocks that each include both a first group of uncommitted logic elements that are configurable into different programmable logic functions and a second group of structural logic elements that are together form a programmable arithmetic sequencer.

11. The integrated circuit according to claim 10 further comprising an interconnect matrix configured to:
programmably connect together the first and second group of logic elements within the same digital blocks;
programmably connect different digital blocks together; and
programmably connect the different digital blocks to external pins and peripherals.

12. The integrated circuit according to claim 11 wherein the programmable arithmetic sequencers in two or more of the digital blocks are coupled together in parallel through the interconnect matrix to form a single arithmetic sequencer with a wider word length.

13. The integrated circuit according to claim 11 wherein the second group of logic elements include a dedicated output multiplexer that programmably connects different output signals from the arithmetic sequencer to other digital blocks through the interconnect matrix.

14. The integrated circuit according to claim 11 wherein the interconnect matrix programmably interconnects digital blocks together that are located in different rows and different columns.

15. The integrated circuit according to claim 10 wherein the second group of logic elements include a memory that stores values that dynamically vary arithmetic functions performed by the arithmetic sequencer.

16. The integrated circuit according to claim 10 wherein the first group of logic elements comprise a programmable logic device and the second group of logic elements comprise first in-first out registers, data registers, accumulators, an arithmetic logic unit, a data shifter, and a data mask register.

17. The integrated circuit according to claim 16 wherein the second group of logic elements include a dedicated set of conditional comparators coupled in parallel with the arithmetic logic unit.

18. A method comprising:
providing an array of universal digital blocks that include both a first set of uncommitted user programmable logic and a second set of dedicated arithmetic sequencer elements;
programming the first set of user programmable logic in at least some of the universal digital blocks into a first set of user programmed logic functions;
programming the second set of dedicated arithmetic sequencer elements in at least some of the universal digital blocks to provide a second set of arithmetic operations that operate in conjunction with the user programmed logic functions; and
programming a routing channel to selectively couple at least some of the first set of user programmed logic functions with at least some of the second set of dedicated arithmetic sequencer elements in different universal digital blocks.

19. The method according to claim 18 further comprising:
programming a micro-controller to monitor data signals; and
dynamically reprogramming the dedicated arithmetic sequencer elements in one or more of the universal digital blocks to perform different arithmetic or logic operations according to the monitored data signals.

20. The method according to claim 19 wherein the micro-controller dynamically changes how the dedicated arithmetic sequencer and programmable logic elements in at least some of the universal digital blocks are coupled together according to the monitored data signals.
